(19) United States
(12) Patent Application Publication
(10) Pub. No.: US 2024/0049107 A1
(43) Pub. Date: Feb. 8, 2024

(54) MULTIPLEXED TRANSMISSION AND RECEPTION OF RELAY NODE

(71) Applicant: Intel Corporation, Santa Clara, CA (US)

(72) Inventors: Qinghua LI, San Ramon, CA (US); Juan Fang, Portland, OR (US); Po-Kai Huang, San Jose, CA (US); Robert Stacey, Portland, OR (US); Laurent Cariou, Milizac (FR)

(73) Assignee: Intel Corporation, Santa Clara, CA (US)

(21) Appl. No.: 18/381,651

(22) Filed: Oct. 19, 2023

Related U.S. Application Data
(60) Provisional application No. 63/482,632, filed on Feb. 1, 2023.

(51) Int. Cl. H04W 40/22; H04L 45/74

(52) U.S. Cl. CPC H04W 40/22; H04L 45/74; H04W 84/12

(57) ABSTRACT

Provided herein are apparatuses and methods for multiplexed transmission and reception of Relay node. An apparatus includes interface circuitry; and processor circuitry coupled with the interface circuitry, wherein the processor circuitry is to: decode a first-hop message received from a first node via the interface circuitry to obtain a message body; generate, in response to the first-hop message, a first-hop response message for transmission to the first node; generate a second-hop message including the message body for transmission to a second node; and multiplex the first-hop response message with the second-hop message in a same frame for transmission of the first-hop response message and the second-hop message simultaneously. Other embodiments are described and claimed.

### CROSS REFERENCE TO RELATED APPLICATION

The present application is based upon and claims the benefits of U.S. provisional Patent Application No. 63/482,632 filed on Feb. 1, 2023, the entire contents of which are incorporated herein by reference.

### TECHNICAL FIELD

Embodiments of the present disclosure generally relate to wireless communication, and in particular to apparatuses and methods for multiplexed transmission and reception of Relay node.

### BACKGROUND ART

Relay is introduced in wireless fidelity (Wi-Fi), e.g., next generation Wi-Fi standard (Wi-Fi 8). With relay, communication range, especially long range application, can be extended. Technical solutions for relay are being studied.

### BRIEF DESCRIPTION OF THE DRAWINGS

Embodiments of the disclosure will be illustrated, by way of example and not limitation, in the figures of the accompanying drawings in which like reference numerals refer to similar elements.

FIG. 1 is a network diagram illustrating an example network environment in accordance with one or more example embodiments of the present disclosure.

FIG. 2 illustrates an example of 2-hop relay in accordance with one or more example embodiments of the present disclosure.

FIG. 3 illustrates an example of 2-hop relay in accordance with one or more example embodiments of the present disclosure.

FIG. 4 illustrates an example of 2-hop relay in accordance with one or more example embodiments of the present disclosure.

FIG. 5 illustrates an example of 2-hop relay in accordance with one or more example embodiments of the present disclosure.

FIG. 6 illustrates an example of communication mode of a Relay node in accordance with one or more example embodiments of the present disclosure.

FIG. 7 illustrates an example of communication mode of a Relay node in accordance with one or more example embodiments of the present disclosure.

FIG. 8 illustrates a flowchart for a method for multiplexed transmission and reception of Relay node in accordance with one or more example embodiments of the present disclosure.

FIG. 9 illustrates a functional diagram of an exemplary communication station that may be suitable for use as a user device, in accordance with one or more example embodiments of the present disclosure.

FIG. 10 illustrates a block diagram of an example machine upon which any of one or more techniques (e.g., methods) may be performed, in accordance with one or more example embodiments of the present disclosure.

FIG. 11 is a block diagram of a radio architecture in accordance with some examples.

FIG. 12 illustrates an example front-end module circuitry for use in the radio architecture of FIG. 11, in accordance with one or more example embodiments of the present disclosure.

FIG. 13 illustrates an example radio IC circuitry for use in the radio architecture of FIG. 11, in accordance with one or more example embodiments of the present disclosure.

FIG. 14 illustrates an example baseband processing circuitry for use in the radio architecture of FIG. 11, in accordance with one or more example embodiments of the present disclosure.

### DETAILED DESCRIPTION OF EMBODIMENTS

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

Relay has been proposed for extending the range of Wi-Fi 8. When the first hop and the second hop are on the same band, the efficiency decreases, and the latency increases significantly. Technical solutions for relay are proposed in the disclosure.

FIG. 1 is a network diagram illustrating an example network environment according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

In some embodiments, the wireless network 100 may further include one or more Relay nodes 140 which may forward communication, e.g., data, signaling or the like, between the AP(s) 102 and the user device(s) 120.

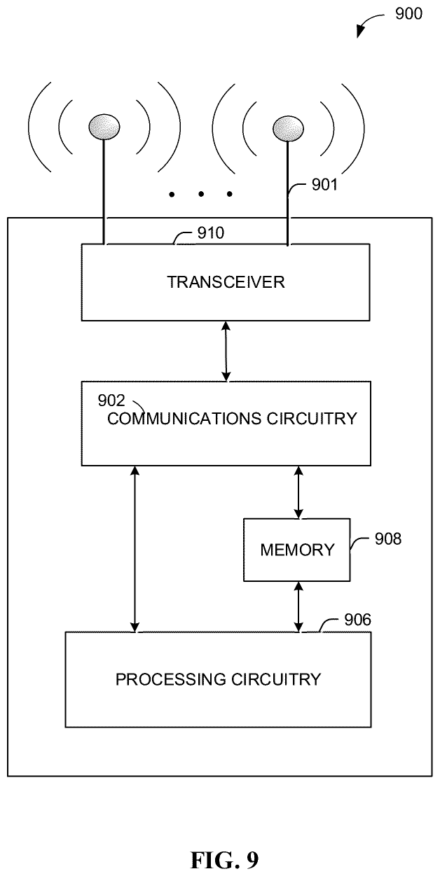

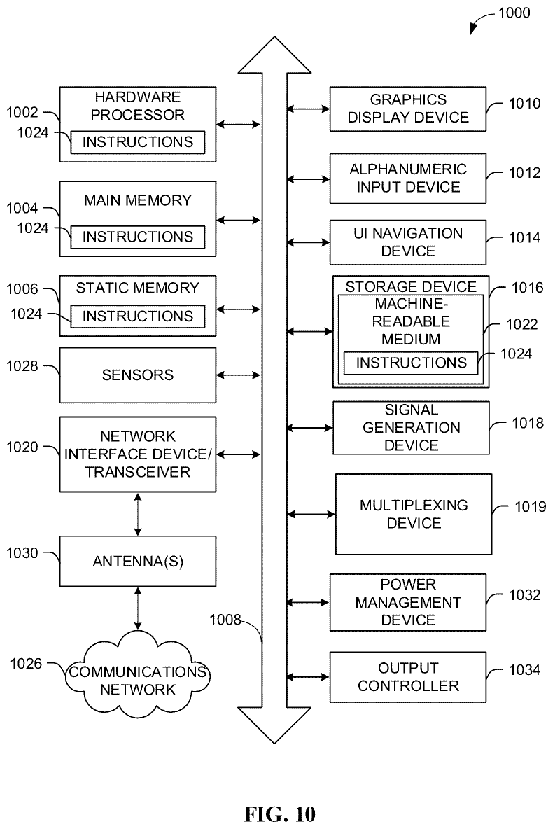

In some embodiments, the user devices 120, the AP 102, and the Relay node 140 may include one or more computer systems similar to that of the functional diagram of FIG. 9 and/or the example machine/system of FIG. 10.

One or more illustrative user device(s) 120, AP(s) 102, and/or Relay node(s) 140 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120, AP(s) 102, and/or Relay node(s) 140 may be STAs. The one or more illustrative user device(s) 120, AP(s) 102, and/or Relay node(s) 140 may operate as a personal basic service set (PBSS) control point/access point (PCP/AP). The user device(s) 120 (e.g., 124, 126, or 128) AP(s) 102 and/or Relay node(s) 140 may include any suitable processor-driven device including, but not limited to, a mobile device or a non-mobile, e.g., a static device. For example, user device(s) 120, AP(s) 102, and/or Relay node(s) 140 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook TM computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an AN device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120, AP(s) 102, and/or Relay node(s) 140 may also include mesh stations in, for example, a mesh network, in accordance with one or more IEEE 802.11 standards and/or 3GPP standards.

Any of the user device(s) 120 (e.g., user devices 124, 126, 128), AP(s) 102, and Relay node(s) 140 may be configured to communicate with each other via one or more communications networks 130 and/or 135 wirelessly or wired. The user device(s) 120 may also communicate peer-to-peer or directly with each other with or without the AP(s) 102 and/or the Relay node(s) 140. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof

Any of the user device(s) 120 (e.g., user devices 124, 126, 128), AP(s) 102, and Relay node(s) 140 may include one or more communications antennas. The one or more communications antennas may be any suitable type of antennas corresponding to the communications protocols used by the user device(s) 120 (e.g., user devices 124, 126 and 128), AP(s) 102, and Relay node(s) 140. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120, AP(s) 102, and/or Relay node(s) 140.

Any of the user device(s) 120 (e.g., user devices 124, 126, 128), AP(s) 102, and Relay node(s) 140 may be configured to perform directional transmission and/or directional reception in conjunction with wirelessly communicating in a wireless network. Any of the user device(s) 120 (e.g., user devices 124, 126, 128), AP(s) 102, and Relay node(s) 140 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), AP(s) 102, and Relay node(s) 140 may be configured to perform any given directional transmission towards one or more defined transmit sectors. Any of the user device(s) 120 (e.g., user devices 124, 126, 128), AP(s) 102, and Relay node(s) 140 may be configured to perform any given directional reception from one or more defined receive sectors.

MIMO beamforming in a wireless network may be accomplished using RF beamforming and/or digital beamforming. In some embodiments, in performing a given MIMO transmission, user devices 120, AP(s) 102, and/or Relay node(s) 140 may be configured to use all or a subset of its one or more communications antennas to perform MIMO beamforming.

Any of the user devices 120 (e.g., user devices 124, 126, 128), AP(s) 102, and Relay node(s) 140 may include any suitable radio and/or transceiver for transmitting and/or receiving radio frequency (RF) signals in the bandwidth and/or channels corresponding to the communications protocols utilized by any of the user device(s) 120, AP(s) 102, and Relay node(s) 140 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In some embodiments, and with reference to FIG. 1, the Relay node(s) 140 may facilitate multiplexed transmission and reception between the AP(s) 102 and the user device(s) 120.

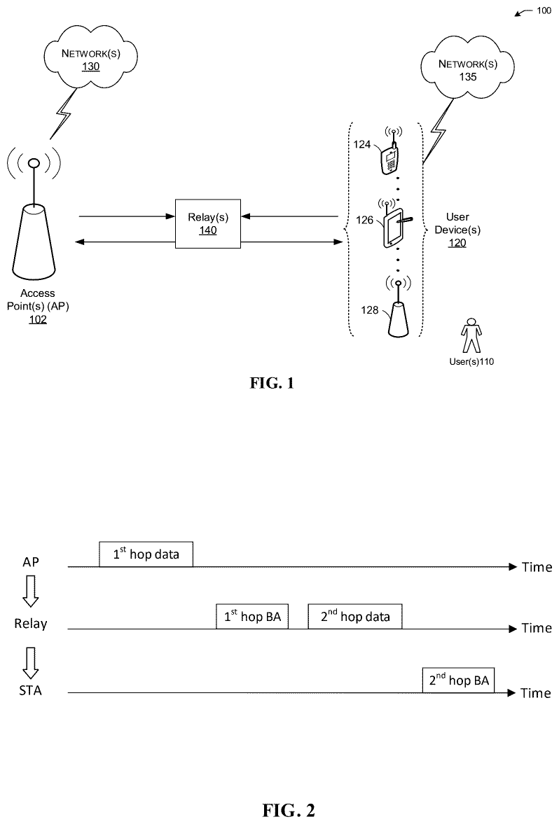

FIG. 2 illustrates an example of 2-hop relay in accordance with one or more example embodiments of the present disclosure. As shown in FIG. 2, downlink data, e.g., the medium access control (MAC) protocol data unit (MPDU), is sent from the AP to the Relay node in the first hop (1^{st} hop data) and then forwarded by the Relay node to the STA in the second-hop (2^{nd} hop data). The downlink data received by the Relay node is acknowledged with the block ack (BA) denoted by 1^{st} hop BA. Similarly, the downlink data received by the STA is acknowledged with the block ack denoted by 2^{nd} hop BA. That is, in response to the 1^{st} hop data, the Relay node may transmit the 1^{st} hop BA to the AP and then transmit the 2^{nd} hop data to the STA for forwarding the downlink data. In response to the 2^{nd} hop data, the STA may transmit the 2^{nd} hop BA to the Relay node.

In this embodiment, four physical layer (PHY) protocol data units (PPDUs) are required for the two hops, e.g., one data frame and one BA frame for each hop. There are overheads associated with each PPDU transmission. First, there is at least one short interframe space (SIFS) duration before the PPDU. Second, there is a legacy preamble in each PPDU. Third, there are MAC and PHY paddings and packet extension in each PPDU. Fourth, because each hop may need to contend for the channel individually, some backoff time is incurred. These overheads consume about more than, for example, 40 μs, which significantly reduces the throughput.

To reduce some of these overheads, in some embodiments, the 1^{st} hop BA is removed. In this way, overhead for the 1^{st} hop BA is reduced. However, removing the 1^{st} hop BA causes some problems. For example, the link adaptation of AP is difficult, because AP can't differentiate the errors of the two hops. Although AP may listen to the 1^{st} hop data to identify the lost MPDUs, this may not be feasible if the second-hop Modulation and Coding Scheme (MCS) is higher than the first-hop MCS.

To reduce some of these overheads while avoiding the above problems, in some embodiments, the Relay node may send messages to both the AP and the STA simultaneously in a multiplexed PPDU.

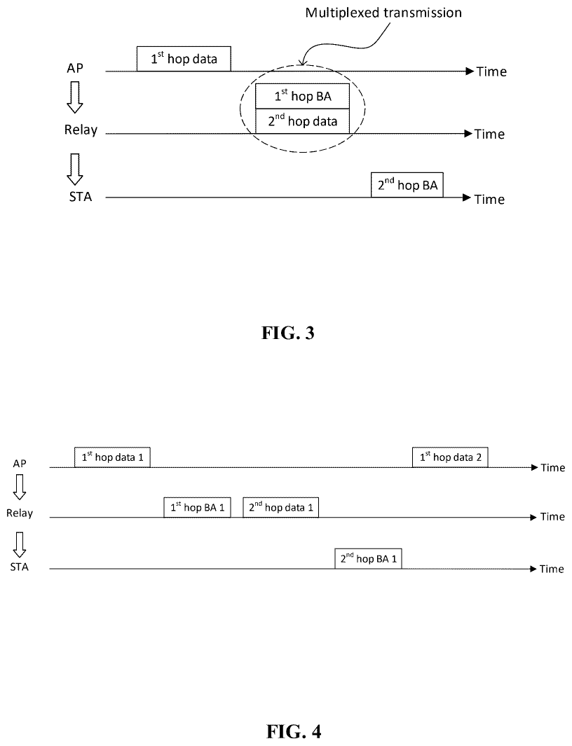

FIG. 3 illustrates an example of 2-hop relay in accordance with one or more example embodiments of the present disclosure. As shown in FIG. 3, the 1^{st} hop BA and the 2^{nd} hop data are multiplexed and transmitted simultaneously by the Relay node. In this way, some of those overheads are reduced. For example, at least SIFS, legacy preamble and/or MAC and PHY paddings and packet extension for one PPDU is reduced as compared to the embodiments shown in FIG. 2. The overhead and latency reductions are more apparent in a series of data transmissions.

FIG. 4 illustrates an example of 2-hop relay in accordance with one or more example embodiments of the present disclosure. The example in FIG. 4 is similar as that of FIG. 2, but differs in that the example shown in FIG. 4 illustrates a series of data transmissions.

As shown in FIG. 4, 1^{st} hop data 1 is sent from the AP to the Relay node. In response to the 1^{st} hop data 1, the Relay node transmits the 1^{st} hop BA 1 to the AP and then transmit the 2^{nd} hop data 1 to the STA. In response to the 2^{nd} hop data 1, the STA transmits the 2^{nd} hop BA 1 to the Relay node. After successful transmission of data 1, the AP starts to transmit the 1^{st} hop data 2 to the Relay node for transmission of data 2.

As mentioned above, the embodiments of FIG. 4 also produce some overheads e.g., SIFS duration before the PPDU, legacy preamble in each PPDU, MAC and PHY paddings and packet extension in each PPDU, backoff time, and the like. These overheads consume more time in series data transmission, so that the throughput is more significantly reduced.

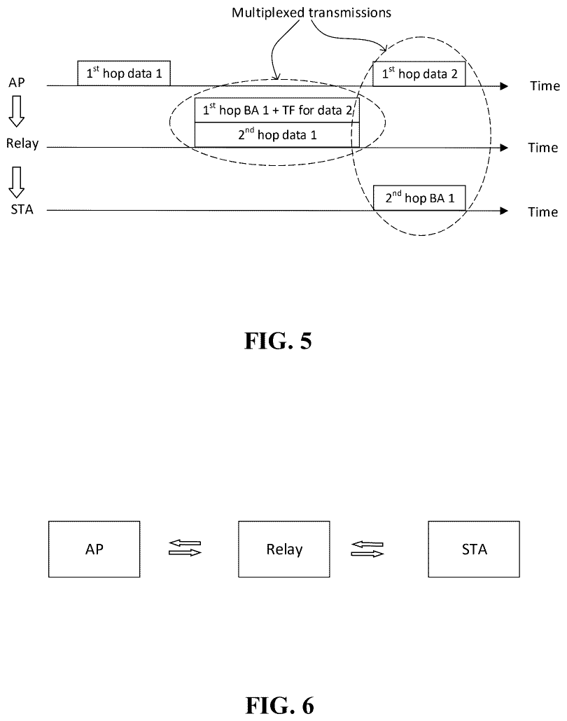

FIG. 5 illustrates an example of 2-hop relay in accordance with one or more example embodiments of the present disclosure. The example in FIG. 5 is similar as that of FIG. 3, but differs in that the example shown in FIG. 4 illustrates a series of data transmissions.

As shown in FIG. 5, the 1^{st} hop data 2 frame can be sent simultaneously with the 2^{nd} hop BA 1 frame, and the 1^{st} hop BA 1 frame can be sent simultaneously with the 2^{nd} hop data 1 frame. As shown, the Relay node receives data 1 in the 1^{st} hop data 1 from the AP. Then the Relay node forwards the received data to the STA using the 2^{nd} hop data 1 and meanwhile sends the 1^{st} hop BA 1 to the AP together with a trigger frame (TF) for a subsequent data transmission (1^{st} hop data 2). In response, the Relay node receives the 1^{st} hop data 2 from the AP and the 2^{nd} hop BA 1 from the STA simultaneously.

As described above, the Relay node may perform simultaneous bidirectional transmission and reception. The embodiments above are described with respect to downlink. However, the principle of the disclosure is also applicable to uplink, which is not limited in the disclosure. Additionally, the embodiments above are described with respect to two hops. However, the principle of the disclosure is also applicable to more than two hops, which is not limited in the disclosure. Furthermore, the embodiments above are described with respect to data and BA frames. However, the principle of the disclosure is also applicable to other frames, e.g., management frame, control frame, sounding frame, feedback frame, or the like, which is not limited in the disclosure.

The embodiments above are described with respect to a single link, e.g., the Relay node is communicated with one AP and one STA. However, the principle of the disclosure is also applicable to multiuser (MU) mode, e.g., orthogonal frequency division multiple access (OFDMA) mode, MU-MIMO mode, or the like, which is not limited in the disclosure. Below, embodiments are described with respect to simultaneous transmission and reception of Relay node in MU mode.

In OFDMA mode, different Resource units (RUs) of different sizes and/or different Modulation and Coding Schemes (MCSs) may be allocated to the traffics to or from AP and STA, respectively according to their payload sizes and the corresponding channel qualities. Similarly, in MU-MIMO mode, different spatial streams and/or different MCSs may be allocated to the traffics to or from AP and STA, respectively according to their payload sizes and the corresponding channel qualities.

In addition to a single STA, when AP sends (or receives) a multiuser PPDU to (or from) multiple STAs, Relay node can forward the MPDUs that Relay node needs to forward to (or from) multiple STAs simultaneously using multiplexed transmissions.

FIG. 6 illustrates an example of communication mode of a Relay node in accordance with one or more example embodiments of the present disclosure. As shown, the AP, the Relay node and the STA act as respective roles. In such a communication mode, new frame types or subtypes may be defined in related specification to support such multiplexed transmission and reception of the Relay node.

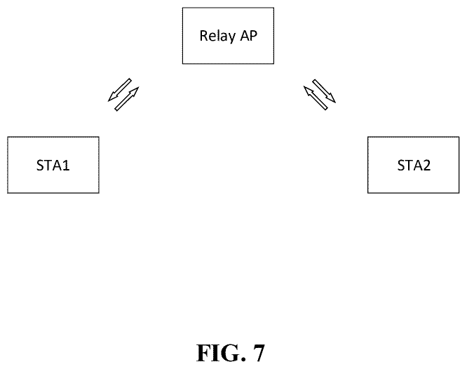

Instead of defining new frames, another communication mode the Relay mode is proposed for maximizing the backward compatibility. FIG. 7 illustrates an example of communication mode of a Relay node in accordance with one or more example embodiments of the present disclosure. As shown, instead of making the Relay node as a client station of the AP as in FIG. 6 in the first hop, the Relay node may act as an AP of the source and destination stations as shown in FIG. 7 for the relay operations. The source and destination stations denoted by STA 1 and STA 2 in FIG. 7 may be the AP and STA in FIG. 6 respectively.

In some embodiments, by acting as an AP, the Relay node denoted by Relay AP in FIG. 7 may use the conventional operations of multiuser uplink and multiuser downlink for multiplexing the traffics of AP and STA in FIG. 6. For example, the Relay AP may use trigger-based uplink to solicit and allocate resources for the uplink transmissions from STA 1 and STA 2. The uplink transmissions may be a data frame, BA frame, Neighbor Discovery Protocol (NDP) sounding frame, Channel State Information (CSI) feedback frame, Clear To Send (CTS) frame, and others. Similarly, the Relay AP may use downlink MU-MIMO and/or downlink OFDMA to send traffics to STA 1 and STA 2 for multiplexing the downlink transmissions. In addition to one relayed link, the Relay AP can support multiple relayed links simultaneously.

In some embodiments, for MU mode, the routing may be based on destination address, e.g., PHY address (e.g., Association Identifier (AID)), MAC address, and the like. In some embodiments, the Relay AP may build and maintain a routing table using the addresses. For example, the Relay AP may receive a PPDU from STA 1 (or STA 2) and read the AID of STA 2 (or STA 1) such that the Relay AP may know that the payload of this PPDU needs to be forward to STA 2 (or STA 1). In this example, the routing is based on physical layer address AID. Additionally or alternatively, in another example, the routing may be based on MAC address. The Relay AP may read the MAC payload of a PPDU (e.g., a MPDU) sent by STA 1 and find that the receiver address is STA 2's MAC address. The Relay AP then may forward the MPDU to STA 2 according to the routing table.

In some embodiments, the AP and STA may need to get some AIDs from the Relay node for the MU operation.

In some embodiments, the Relay node may provide some indication for the MU operation. Otherwise, the STA may not be able to determine whether the MU PPDU comes from Relay AP or the real AP.

In some embodiments, BSS color is considered. For example, it is determined whether the STA is in the same BSS with both Relay AP and the real AP. If the Relay AP and the real AP run two different BSSs, then the STA may need to decode PPDUs from the two different BSSs, respectively. If the Relay AP and the real AP share the same BSS and the same BSS color, then the Relay node may need to know the AID of the STA being relayed and an AID used by the real AP.

In some embodiments, the real AP may decode the traffic from the STA in a specific RU or spatial stream of the MU PPDU.

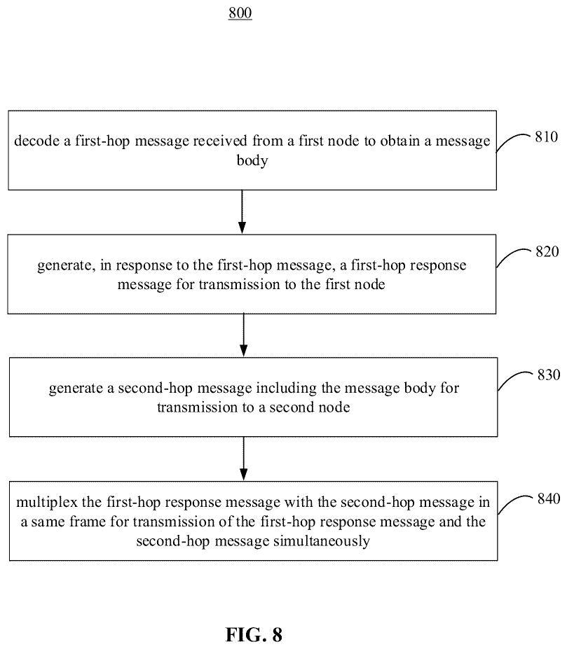

FIG. 8 illustrates a flowchart for a method 800 for multiplexed transmission and reception of Relay node in accordance with one or more example embodiments of the present disclosure. The method 800 may be performed by the Relay node. As shown in FIG. 8, the method 800 may include operations 810 to 840.

At operation 810, a first-hop message received from a first node is decoded to obtain a message body.

At operation 820, in response to the first-hop message, a first-hop response message is generated for transmission to the first node.

At operation 830, a second-hop message including the message body is generated for transmission to a second node.

At operation 840, the first-hop response message is multiplexed with the second-hop message in a same frame for transmission of the first-hop response message and the second-hop message simultaneously.

In some embodiments, the first-hop response message includes a first-hop acknowledgement, e.g., BA.

In some embodiments, the first-hop response message further includes a TF for a next first-hop message.

In some embodiments, the next first-hop message received from the first node is decoded, and a second-hop response message in response to the second-hop message received from the second node is decoded. The next first-hop message and the second-hop response message are received simultaneously.

In some embodiments, the message body includes data, management information, control information, sounding information, or feedback information.

In some embodiments, the first-hop message is decoded to obtain a destination address for the message body; and a routing table is checked to obtain a destination node corresponding to the destination address.

In some embodiments, the destination node includes the second node or a third node.

In some embodiments, the destination address includes a PHY address or a MAC address.

In some embodiments, the first node or the second node includes a STA, an AP, or a Relay node.

In some embodiments, the method is applicable in MU mode.

With the multiplexed transmission and reception of the Relay node, the signals of two hops can be transmitted simultaneously. In this way, communication overheads can be reduced, so that communication efficiency can be increased and latency can be reduced.

FIG. 9 shows a functional diagram of an exemplary communication station 900, in accordance with one or more example embodiments of the present disclosure. In one embodiment, FIG. 9 illustrates a functional block diagram of a communication station that may be suitable for use as an AP 102 (FIG. 1) or a user device 120 (FIG. 1) in accordance with some embodiments. The communication station 900 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 900 may include communications circuitry 902 and a transceiver 910 for transmitting and receiving signals to and from other communication stations using one or more antennas 901. The communications circuitry 902 may include circuitry that can operate the physical layer (PHY) communications and/or medium access control (MAC) communications for controlling access to the wireless medium, and/or any other communications layers for transmitting and receiving signals. The communication station 900 may also include processing circuitry 906 and memory 908 arranged to perform the operations described herein. In some embodiments, the communications circuitry 902 and the processing circuitry 906 may be configured to perform operations detailed in the above figures, diagrams, and flows.

In accordance with some embodiments, the communications circuitry 902 may be arranged to contend for a wireless medium and configure frames or packets for communicating over the wireless medium. The communications circuitry 902 may be arranged to transmit and receive signals. The communications circuitry 902 may also include circuitry for modulation/demodulation, upconversion/downconversion, filtering, amplification, etc. In some embodiments, the processing circuitry 906 of the communication station 900 may include one or more processors. In other embodiments, two or more antennas 901 may be coupled to the communications circuitry 902 arranged for sending and receiving signals. The memory 908 may store information for configuring the processing circuitry 906 to perform operations for configuring and transmitting message frames and performing the various operations described herein. The memory 908 may include any type of memory, including non-transitory memory, for storing information in a form readable by a machine (e.g., a computer). For example, the memory 908 may include a computer-readable storage device, read-only memory (ROM), random-access memory (RAM), magnetic disk storage media, optical storage media, flash-memory devices and other storage devices and media.

In some embodiments, the communication station 900 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 900 may include one or more antennas 901. The antennas 901 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 900 may include one or more of a keyboard, a display, a non-volatile memory port, multiple antennas, a graphics processor, an application processor, speakers, and other mobile device elements. The display may be an LCD screen including a touch screen.

Although the communication station 900 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field- programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 900 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 900 may include one or more processors and may be configured with instructions stored on a computer-readable storage device.

FIG. 10 illustrates a block diagram of an example of a machine 1000 or system upon which any one or more of the techniques (e.g., methodologies) discussed herein may be performed. In other embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environments. The machine 1000 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a power management device 1032, a graphics display device 1010, an alphanumeric input device 1012 (e.g., a keyboard), and a user interface (UI) navigation device 1014 (e.g., a mouse). In an example, the graphics display device 1010, alphanumeric input device 1012, and UI navigation device 1014 may be a touch screen display. The machine 1000 may additionally include a storage device (i.e., drive unit) 1016, a signal generation device 1018 (e.g., a speaker), a multiplexing device 1019, a network interface device/transceiver 1020 coupled to antenna(s) 1030, and one or more sensors 1028, such as a global positioning system (GPS) sensor, a compass, an accelerometer, or other sensor. The machine 1000 may include an output controller 1034, such as a serial (e.g., universal serial bus (USB)), parallel, or other wired or wireless (e.g., infrared (IR), near field communication (NFC), etc.) connection to communicate with or control one or more peripheral devices (e.g., a printer, a card reader, etc.). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1002 for generation and processing of the baseband signals and for controlling operations of the main memory 1004, the storage device 1016, and/or the multiplexing device 1019. The baseband processor may be provided on a single radio card, a single chip, or an integrated circuit (IC).

The storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, or within the hardware processor 1002 during execution thereof by the machine 1000. In an example, one or any combination of the hardware processor 1002, the main memory 1004, the static memory 1006, or the storage device 1016 may constitute machine-readable media.

The multiplexing device 1019 may carry out or perform any of the operations and processes described and shown above.

It is understood that the above are only a subset of what the multiplexing device 1019 may be configured to perform and that other functions included throughout this disclosure may also be performed by the multiplexing device 1019.

While the machine-readable medium 1022 is illustrated as a single medium, the term “machine-readable medium” may include a single medium or multiple media (e.g., a centralized or distributed database, and/or associated caches and servers) configured to store the one or more instructions 1024.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1000 and that cause the machine 1000 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device/transceiver 1020 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1020 may include one or more physical jacks (e.g., Ethernet, coaxial, or phone jacks) or one or more antennas to connect to the communications network 1026. In an example, the network interface device/transceiver 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1000 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

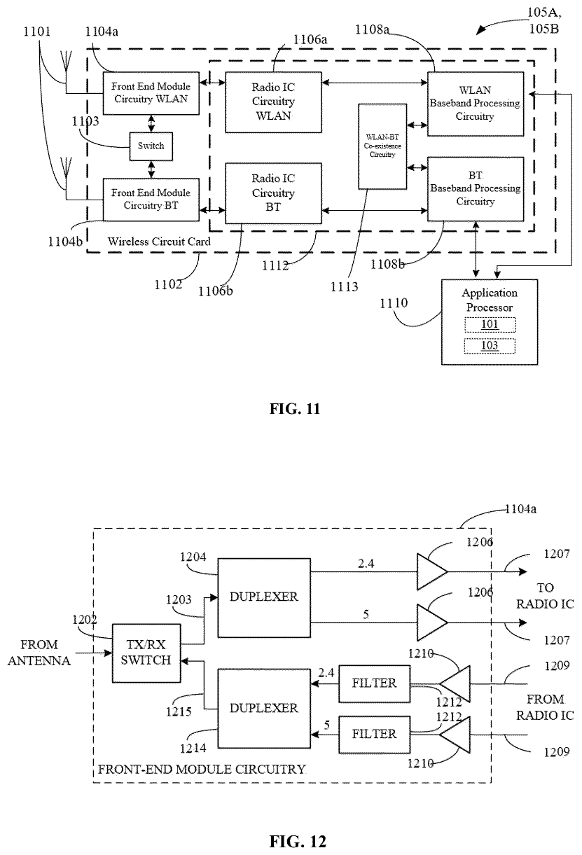

FIG. 11 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1104a-b, radio IC circuitry 1106a-b and baseband processing circuitry 1108a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1104a-b may include a WLAN or Wi-Fi FEM circuitry 1104a and a Bluetooth (BT) FEM circuitry 1104b. The WLAN FEM circuitry 1104a may include a receive signal path comprising circuitry configured to operate on WLAN RF signals received from one or more antennas 1101, to amplify the received signals and to provide the amplified versions of the received signals to the WLAN radio IC circuitry 1106a for further processing. The BT FEM circuitry 1104b may include a receive signal path which may include circuitry configured to operate on BT RF signals received from one or more antennas 1101, to amplify the received signals and to provide the amplified versions of the received signals to the BT radio IC circuitry 1106b for further processing. FEM circuitry 1104a may also include a transmit signal path which may include circuitry configured to amplify WLAN signals provided by the radio IC circuitry 1106a for wireless transmission by one or more of the antennas 1101. In addition, FEM circuitry 1104b may also include a transmit signal path which may include circuitry configured to amplify BT signals provided by the radio IC circuitry 1106b for wireless transmission by the one or more antennas. In the embodiment of FIG. 11, although FEM 1104a and FEM 1104b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1106a-b as shown may include WLAN radio IC circuitry 1106a and BT radio IC circuitry 1106b. The WLAN radio IC circuitry 1106a may include a receive signal path which may include circuitry to down-convert WLAN RF signals received from the FEM circuitry 1104a and provide baseband signals to WLAN baseband processing circuitry 1108a. BT radio IC circuitry 1106b may in turn include a receive signal path which may include circuitry to down-convert BT RF signals received from the FEM circuitry 1104b and provide baseband signals to BT baseband processing circuitry 1108b. WLAN radio IC circuitry 1106a may also include a transmit signal path which may include circuitry to up-convert WLAN baseband signals provided by the WLAN baseband processing circuitry 1108a and provide WLAN RF output signals to the FEM circuitry 1104a for subsequent wireless transmission by the one or more antennas 1101. BT radio IC circuitry 1106b may also include a transmit signal path which may include circuitry to up-convert BT baseband signals provided by the BT baseband processing circuitry 1108b and provide BT RF output signals to the FEM circuitry 1104b for subsequent wireless transmission by the one or more antennas 1101. In the embodiment of FIG. 11, although radio IC circuitries 1106a and 1106b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1108a-b may include a WLAN baseband processing circuitry 1108a and a BT baseband processing circuitry 1108b. The WLAN baseband processing circuitry 1108a may include a memory, such as, for example, a set of RAM arrays in a Fast Fourier Transform or Inverse Fast Fourier Transform block (not shown) of the WLAN baseband processing circuitry 1108a. Each of the WLAN baseband circuitry 1108a and the BT baseband circuitry 1108b may further include one or more processors and control logic to process the signals received from the corresponding WLAN or BT receive signal path of the radio IC circuitry 1106a-b, and to also generate corresponding WLAN or BT baseband signals for the transmit signal path of the radio IC circuitry 1106a-b. Each of the baseband processing circuitries 1108a and 1108b may further include physical layer (PHY) and medium access control layer (MAC) circuitry, and may further interface with a device for generation and processing of the baseband signals and for controlling operations of the radio IC circuitry 1106a-b.

Referring still to FIG. 11, according to the shown embodiment, WLAN-BT coexistence circuitry 1113 may include logic providing an interface between the WLAN baseband circuitry 1108a and the BT baseband circuitry 1108b to enable use cases requiring WLAN and BT coexistence. In addition, a switch 1103 may be provided between the WLAN FEM circuitry 1104a and the BT FEM circuitry 1104b to allow switching between the WLAN and BT radios according to application needs. In addition, although the antennas 1101 are depicted as being respectively connected to the WLAN FEM circuitry 1104a and the BT FEM circuitry 1104b, embodiments include within their scope the sharing of one or more antennas as between the WLAN and BT FEMs, or the provision of more than one antenna connected to each of FEM 1104a or 1104b.

In some embodiments, the front-end module circuitry 1104a-b, the radio IC circuitry 1106a-b, and baseband processing circuitry 1108a-b may be provided on a single radio card, such as wireless radio card 1102. In some other embodiments, the one or more antennas 1101, the FEM circuitry 1104a-b and the radio IC circuitry 1106a-b may be provided on a single radio card. In some other embodiments, the radio IC circuitry 1106a-b and the baseband processing circuitry 1108a-b may be provided on a single chip or integrated circuit (IC), such as IC 1112. In some embodiments, the wireless radio card 1102 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1108b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160MHz) (with non-contiguous bandwidths). In some embodiments, a 920 MHz channel bandwidth may be used. The scope of the embodiments is not limited with respect to the above center frequencies however.

FIG. 12 illustrates WLAN FEM circuitry 1104a in accordance with some embodiments. Although the example of FIG. 12 is described in conjunction with the WLAN FEM circuitry 1104a, the example of FIG. 12 may be described in conjunction with the example BT FEM circuitry 1104b (FIG. 11), although other circuitry configurations may also be suitable.

In some embodiments, the FEM circuitry 1104a may include a TX/RX switch 1202 to switch between transmit mode and receive mode operation. The FEM circuitry 1104a may include a receive signal path and a transmit signal path. The receive signal path of the FEM circuitry 1104a may include a low-noise amplifier (LNA) 1206 to amplify received RF signals 1203 and provide the amplified received RF signals 1207 as an output (e.g., to the radio IC circuitry 1106a-b (FIG. 11)). The transmit signal path of the circuitry 1104a may include a power amplifier (PA) to amplify input RF signals 1209 (e.g., provided by the radio IC circuitry 1106a-b), and one or more filters 1212, such as band-pass filters (BPFs), low-pass filters (LPFs) or other types of filters, to generate RF signals 1215 for subsequent transmission (e.g., by one or more of the antennas 1101 (FIG. 11)) via an example duplexer 1214.

In some dual-mode embodiments for Wi-Fi communication, the FEM circuitry 1104a may be configured to operate in either the 2.4 GHz frequency spectrum or the 5 GHz frequency spectrum. In these embodiments, the receive signal path of the FEM circuitry 1104a may include a receive signal path duplexer 1204 to separate the signals from each spectrum as well as provide a separate LNA 1206 for each spectrum as shown. In these embodiments, the transmit signal path of the FEM circuitry 1104a may also include a power amplifier 1210 and a filter 1212, such as a BPF, an LPF or another type of filter for each frequency spectrum and a transmit signal path duplexer 1204 to provide the signals of one of the different spectrums onto a single transmit path for subsequent transmission by the one or more of the antennas 1101 (FIG. 11). In some embodiments, BT communications may utilize the 2.4 GHz signal paths and may utilize the same FEM circuitry 1104a as the one used for WLAN communications.

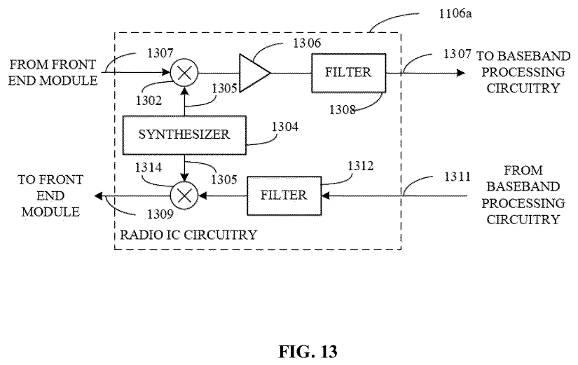

FIG. 13 illustrates radio IC circuitry 1106a in accordance with some embodiments. The radio IC circuitry 1106a is one example of circuitry that may be suitable for use as the WLAN or BT radio IC circuitry 1106a/1106b (FIG. 11), although other circuitry configurations may also be suitable. Alternatively, the example of FIG. 13 may be described in conjunction with the example BT radio IC circuitry 1106b.

In some embodiments, the radio IC circuitry 1106a may include a receive signal path and a transmit signal path. The receive signal path of the radio IC circuitry 1106a may include at least mixer circuitry 1302, such as, for example, down-conversion mixer circuitry, amplifier circuitry 1306 and filter circuitry 1308. The transmit signal path of the radio IC circuitry 1106a may include at least filter circuitry 1312 and mixer circuitry 1314, such as, for example, up-conversion mixer circuitry. Radio IC circuitry 1106a may also include synthesizer circuitry 1304 for synthesizing a frequency 1305 for use by the mixer circuitry 1302 and the mixer circuitry 1314. The mixer circuitry 1302 and/or 1314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 13 illustrates only a simplified version of a radio IC circuitry, and may include, although not shown, embodiments where each of the depicted circuitries may include more than one component. For instance, mixer circuitry 1314 may each include one or more mixers, and filter circuitries 1308 and/or 1312 may each include one or more filters, such as one or more BPFs and/or LPFs according to application needs. For example, when mixer circuitries are of the direct-conversion type, they may each include two or more mixers.

In some embodiments, mixer circuitry 1302 may be configured to down-convert RF signals 1207 received from the FEM circuitry 1104a-b (FIG. 11) based on the synthesized frequency 1305 provided by synthesizer circuitry 1304. The amplifier circuitry 1306 may be configured to amplify the down-converted signals and the filter circuitry 1308 may include an LPF configured to remove unwanted signals from the down-converted signals to generate output baseband signals 1307. Output baseband signals 1307 may be provided to the baseband processing circuitry 1108a-b (FIG. 11) for further processing. In some embodiments, the output baseband signals 1307 may be zero-frequency baseband signals, although this is not a requirement. In some embodiments, mixer circuitry 1302 may comprise passive mixers, although the scope of the embodiments is not limited in this respect.

In some embodiments, the mixer circuitry 1314 may be configured to up-convert input baseband signals 1311 based on the synthesized frequency 1305 provided by the synthesizer circuitry 1304 to generate RF output signals 1209 for the FEM circuitry 1104a-b. The baseband signals 1311 may be provided by the baseband processing circuitry 1108a-b and may be filtered by filter circuitry 1312. The filter circuitry 1312 may include an LPF or a BPF, although the scope of the embodiments is not limited in this respect.

In some embodiments, the mixer circuitry 1302 and the mixer circuitry 1314 may each include two or more mixers and may be arranged for quadrature down-conversion and/or up-conversion respectively with the help of synthesizer 1304. In some embodiments, the mixer circuitry 1302 and the mixer circuitry 1314 may each include two or more mixers each configured for image rejection (e.g., Hartley image rejection). In some embodiments, the mixer circuitry 1302 and the mixer circuitry 1314 may be arranged for direct down-conversion and/or direct up-conversion, respectively. In some embodiments, the mixer circuitry 1302 and the mixer circuitry 1314 may be configured for super-heterodyne operation, although this is not a requirement.

Mixer circuitry 1302 may comprise, according to one embodiment: quadrature passive mixers (e.g., for the in-phase (I) and quadrature phase (Q) paths). In such an embodiment, RF input signal 1207 from FIG. 13 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1305 of synthesizer 1304 (FIG. 13). In some embodiments, the LO frequency may be the carrier frequency, while in other embodiments, the LO frequency may be a fraction of the carrier frequency (e.g., one -half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1207 (FIG. 12) may comprise a balanced signal, although the scope of the embodiments is not limited in this respect. The I and Q baseband output signals may be provided to low-noise amplifier, such as amplifier circuitry 1306 (FIG. 13) or to filter circuitry 1308 (FIG. 13).

In some embodiments, the output baseband signals 1307 and the input baseband signals 1311 may be analog baseband signals, although the scope of the embodiments is not limited in this respect. In some alternate embodiments, the output baseband signals 1307 and the input baseband signals 1311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1304 may be a fractional-N synthesizer or a fractional N/N+1 synthesizer, although the scope of the embodiments is not limited in this respect as other types of frequency synthesizers may be suitable. For example, synthesizer circuitry 1304 may be a delta-sigma synthesizer, a frequency multiplier, or a synthesizer comprising a phase-locked loop with a frequency divider. According to some embodiments, the synthesizer circuitry 1304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1304 may be provided by a voltage controlled oscillator (VCO), although that is not a requirement. A divider control input may further be provided by either the baseband processing circuitry 1108a-b (FIG. 11) depending on the desired output frequency 1305. In some embodiments, a divider control input (e.g., N) may be determined from a look-up table (e.g., within a Wi-Fi card) based on a channel number and a channel center frequency as determined or indicated by the example application processor 1110. The application processor 1110 may include, or otherwise be connected to, one of the example secure signal converter 101 or the example received signal converter 103 (e.g., depending on which device the example radio architecture is implemented in).

In some embodiments, synthesizer circuitry 1304 may be configured to generate a carrier frequency as the output frequency 1305, while in other embodiments, the output frequency 1305 may be a fraction of the carrier frequency (e.g., one-half the carrier frequency, one-third the carrier frequency). In some embodiments, the output frequency 1305 may be a LO frequency (fLO).

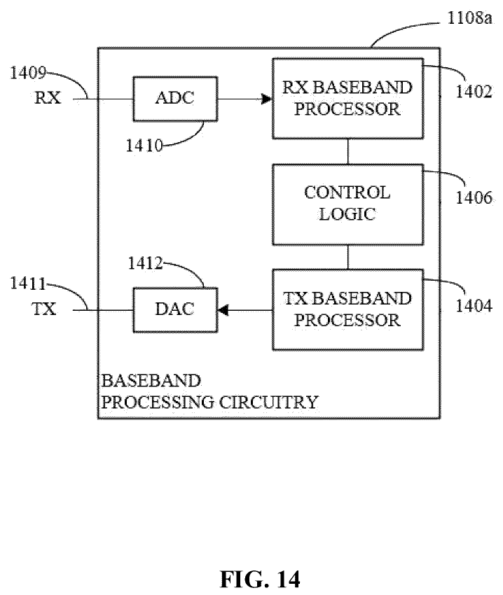

FIG. 14 illustrates a functional block diagram of baseband processing circuitry 1108a in accordance with some embodiments. The baseband processing circuitry 1108a is one example of circuitry that may be suitable for use as the baseband processing circuitry 1108a (FIG. 11), although other circuitry configurations may also be suitable. Alternatively, the example of FIG. 13 may be used to implement the example BT baseband processing circuitry 1108b of FIG. 11.

The baseband processing circuitry 1108a may include a receive baseband processor (RX BBP) 1402 for processing receive baseband signals 1309 provided by the radio IC circuitry 1106a-b (FIG. 11) and a transmit baseband processor (TX BBP) 1404 for generating transmit baseband signals 1311 for the radio IC circuitry 1106a-b. The baseband processing circuitry 1108a may also include control logic 1406 for coordinating the operations of the baseband processing circuitry 1108a.

In some embodiments (e.g., when analog baseband signals are exchanged between the baseband processing circuitry 1108a-b and the radio IC circuitry 1106a-b), the baseband processing circuitry 1108a may include ADC 1410 to convert analog baseband signals 1409 received from the radio IC circuitry 1106a-b to digital baseband signals for processing by the RX BBP 1402. In these embodiments, the baseband processing circuitry 1108a may also include DAC 1412 to convert digital baseband signals from the TX BBP 1404 to analog baseband signals 1411.

In some embodiments that communicate OFDM signals or OFDMA signals, such as through baseband processor 1108a, the transmit baseband processor 1404 may be configured to generate OFDM or OFDMA signals as appropriate for transmission by performing an inverse fast Fourier transform (IFFT). The receive baseband processor 1402 may be configured to process received OFDM signals or OFDMA signals by performing an FFT. In some embodiments, the receive baseband processor 1402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 11, in some embodiments, the antennas 1101 (FIG. 11) may each comprise one or more directional or omnidirectional antennas, including, for example, dipole antennas, monopole antennas, patch antennas, loop antennas, micro strip antennas or other types of antennas suitable for transmission of RF signals. In some multiple-input multiple-output (MIMO) embodiments, the antennas may be effectively separated to take advantage of spatial diversity and the different channel characteristics that may result. Antennas 1101 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (AN) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like. Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following paragraphs describe examples of various embodiments.

Example 1 includes an apparatus, comprising: interface circuitry; and processor circuitry coupled with the interface circuitry, wherein the processor circuitry is to: decode a first-hop message received from a first node via the interface circuitry to obtain a message body; generate, in response to the first-hop message, a first-hop response message for transmission to the first node; generate a second-hop message including the message body for transmission to a second node; and multiplex the first-hop response message with the second-hop message in a same frame for transmission of the first-hop response message and the second-hop message simultaneously.

Example 2 includes the apparatus of Example 1, wherein the first-hop response message includes a first-hop acknowledgement.

Example 3 includes the apparatus of Example 1 or 2, wherein the first-hop response message further includes a trigger frame (TF) for a next first-hop message.

Example 4 includes the apparatus of any of Examples 1 to 3, wherein the processor circuitry is further to: decode the next first-hop message received from the first node via the interface circuitry; and decode a second-hop response message in response to the second-hop message received from the second node via the interface circuitry, wherein the next first-hop message and the second-hop response message are received simultaneously.

Example 5 includes the apparatus of any of Examples 1 to 4, wherein the message body includes data, management information, control information, sounding information, or feedback information.

Example 6 includes the apparatus of any of Examples 1 to 5, wherein the processor circuitry is further to: decode the first-hop message to obtain a destination address for the message body; and check a routing table to obtain a destination node corresponding to the destination address.

Example 7 includes the apparatus of any of Examples 1 to 6, wherein the destination node includes the second node or a third node.

Example 8 includes the apparatus of any of Examples 1 to 7, wherein the destination address includes a physical layer (PHY) address or a medium access control layer (MAC) address.

Example 9 includes the apparatus of any of Examples 1 to 8, wherein the first node or the second node includes a station (STA), an access point (AP), or a Relay node.

Example 10 includes the apparatus of any of Examples 1 to 9, wherein the apparatus is applicable to a Relay node.

Example 11 includes the apparatus of any of Examples 1 to 10, wherein the apparatus is configured to operate in multiuser (MU) mode.

Example 12 includes a method, comprising: decoding a first-hop message received from a first node to obtain a message body; generating, in response to the first-hop message, a first-hop response message for transmission to the first node; generating a second-hop message including the message body for transmission to a second node; and multiplexing the first-hop response message with the second-hop message in a same frame for transmission of the first-hop response message and the second-hop message simultaneously.

Example 13 includes the method of Example 12, wherein the first-hop response message includes a first-hop acknowledgement.

Example 14 includes the method of Example 12 or 13, wherein the first-hop response message further includes a trigger frame (TF) for a next first-hop message.

Example 15 includes the method of any of Examples 12 to 14, further comprising: decoding the next first-hop message received from the first node; and decoding a second-hop response message in response to the second-hop message received from the second node, wherein the next first-hop message and the second-hop response message are received simultaneously.

Example 16 includes the method of any of Examples 12 to 15, wherein the message body includes data, management information, control information, sounding information, or feedback information.

Example 17 includes the method of any of Examples 12 to 16, further comprising: decoding the first-hop message to obtain a destination address for the message body; and checking a routing table to obtain a destination node corresponding to the destination address.

Example 18 includes the method of any of Examples 12 to 17, wherein the destination node includes the second node or a third node.

Example 19 includes the method of any of Examples 12 to 18, wherein the destination address includes a physical layer (PHY) address or a medium access control layer (MAC) address.

Example 20 includes the method of any of Examples 12 to 19, wherein the first node or the second node includes a station (STA), an access point (AP), or a Relay node.

Example 21 includes the method of any of Examples 12 to 20, wherein the method is applicable to a Relay node.

Example 22 includes the method of any of Examples 12 to 21, wherein the method is applicable in multiuser (MU) mode.

Example 23 includes an apparatus, comprising: means for decoding a first-hop message received from a first node to obtain a message body; means for generating, in response to the first-hop message, a first-hop response message for transmission to the first node; means for generating a second-hop message including the message body for transmission to a second node; and means for multiplexing the first-hop response message with the second-hop message in a same frame for transmission of the first-hop response message and the second-hop message simultaneously.

Example 24 includes the apparatus of Example 23, wherein the first-hop response message includes a first-hop acknowledgement.

Example 25 includes the apparatus of Example 23 or 24, wherein the first-hop response message further includes a trigger frame (TF) for a next first-hop message.

Example 26 includes the apparatus of any of Examples 23 to 25, further comprising: means for decoding the next first-hop message received from the first node; and means for decoding a second-hop response message in response to the second-hop message received from the second node, wherein the next first-hop message and the second-hop response message are received simultaneously.

Example 27 includes the apparatus of any of Examples 23 to 26, wherein the message body includes data, management information, control information, sounding information, or feedback information.

Example 28 includes the apparatus of any of Examples 23 to 27, further comprising: means for decoding the first-hop message to obtain a destination address for the message body; and means for checking a routing table to obtain a destination node corresponding to the destination address.

Example 29 includes the apparatus of any of Examples 23 to 28, wherein the destination node includes the second node or a third node.

Example 30 includes the apparatus of any of Examples 23 to 29, wherein the destination address includes a physical layer (PHY) address or a medium access control layer (MAC) address.

Example 31 includes the apparatus of any of Examples 23 to 30, wherein the first node or the second node includes a station (STA), an access point (AP), or a Relay node.

Example 32 includes the apparatus of any of Examples 23 to 31, wherein the apparatus is applicable to a Relay node.

Example 33 includes the apparatus of any of Examples 23 to 32, wherein the apparatus is applicable to operate in multiuser (MU) mode.

Example 34 includes a computer-readable medium having instructions stored thereon, wherein the instructions, when executed by processing circuitry of a Relay node, cause the processing circuitry to perform the method of any of Examples 12 to 22.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An apparatus, comprising:
interface circuitry; and
processor circuitry coupled with the interface circuitry, wherein the processor circuitry is to:
decode a first-hop message received from a first node via the interface circuitry to obtain a message body;
generate, in response to the first-hop message, a first-hop response message for transmission to the first node;
generate a second-hop message including the message body for transmission to a second node; and
multiplex the first-hop response message with the second-hop message in a same frame for transmission of the first-hop response message and the second-hop message simultaneously.

2. The apparatus of claim 1, wherein the first-hop response message includes a first-hop acknowledgement.

3. The apparatus of claim 2, wherein the first-hop response message further includes a trigger frame (TF) for a next first-hop message.

4. The apparatus of claim 3, wherein the processor circuitry is further to:
decode the next first-hop message received from the first node via the interface circuitry; and
decode a second-hop response message in response to the second-hop message received from the second node via the interface circuitry,
wherein the next first-hop message and the second-hop response message are received simultaneously.

5. The apparatus of claim 1, wherein the message body includes data, management information, control information, sounding information, or feedback information.

6. The apparatus of claim 1, wherein the processor circuitry is further to:
decode the first-hop message to obtain a destination address for the message body; and
check a routing table to obtain a destination node corresponding to the destination address.

7. The apparatus of claim 6, wherein the destination node includes the second node or a third node.

8. The apparatus of claim 6, wherein the destination address includes a physical layer (PHY) address or a medium access control layer (MAC) address.

9. The apparatus of claim 1, wherein the first node or the second node includes a station (STA), an access point (AP), or a Relay node.

10. The apparatus of claim 1, wherein the apparatus is applicable to a Relay node.

11. The apparatus of claim 1, wherein the apparatus is configured to operate in multiuser (MU) mode.

12. A method, comprising:
decoding a first-hop message received from a first node to obtain a message body;
generating, in response to the first-hop message, a first-hop response message for transmission to the first node;
generating a second-hop message including the message body for transmission to a second node; and
multiplexing the first-hop response message with the second-hop message in a same frame for transmission of the first-hop response message and the second-hop message simultaneously.

13. The method of claim 12, wherein the first-hop response message includes a first-hop acknowledgement.

14. The method of claim 13, wherein the first-hop response message further includes a trigger frame (TF) for a next first-hop message.

15. The method of claim 14, further comprising:
decoding the next first-hop message received from the first node; and
decoding a second-hop response message in response to the second-hop message received from the second node,
wherein the next first-hop message and the second-hop response message are received simultaneously.

16. The method of claim 12, wherein the message body includes data, management information, control information, sounding information, or feedback information.

17. The method of claim 12, further comprising:
decoding the first-hop message to obtain a destination address for the message body; and
checking a routing table to obtain a destination node corresponding to the destination address.

18. The method of claim 17, wherein the destination node includes the second node or a third node.

19. The method of claim 17, wherein the destination address includes a physical layer (PHY) address or a medium access control layer (MAC) address.

20. The method of claim 12, wherein the first node or the second node includes a station (STA), an access point (AP), or a Relay node.
